(19) United States
(12) Patent Application Publication
(10) Pub. No.: US 2006/0121428 A1
(43) Pub. Date: Jun. 8, 2006

(54) Electronic token economy media access as reinforcement

(76) Inventor: Alejandro Terrazas, East Lansing, MI (US)

Correspondence Address: GREENBERG & LIEBERMAN, LLC, 2141 WISCONSIN AVE, N.W., SUITE C-2, WASHINGTON, DC, 20007, US

(21) Appl. No.: 10/975,972

(22) Filed: Oct. 28, 2004

(51) Int. Cl. G09B 19/00

(52) U.S. Cl. 434/238

(57) ABSTRACT

A behavior modification device wherein points are accumulated based upon certain behavior, and then the accumulated points can be redeemed for time spent with a multimedia device. A sensor auto determines points to be accumulated, or alternatively, a third party agent (teacher, parent or guardian) can input points observed while a subject is performing certain activities or exhibiting certain behaviors. The points are stored in a device that is positioned in communication with a multimedia device, or alternatively, the storage device can be a wristwatch or other portable device carried by the subject. The subject, when allowing the storage device to communicate with the multimedia device, can operate the multimedia device assuming the storage device contains enough points for operating the multimedia device.

### CLAIM TO PRIORITY

Priority is hereby claimed to U.S. patent application Ser. No. 60/487,833 filed on Dec. 26, 2003.

### FIELD OF THE INVENTION

The present invention is a device for behavior modification and control, and more particularly, a system wherein media access credits are provided to a subject upon performance of certain behaviors or tasks.

### BACKGROUND OF THE INVENTION

Behavior modification, or encouraging a subject to act in a certain manner, can be accomplished in many ways. Traditionally, parents have purchased gifts for children to reinforce desired behavior. For example, if a child completes homework, then the child receives a toy. Similarly, parents have discouraged undesirable behavior with a spanking or loss of a privilege. Such systems have existed, most likely, well before the written word.

In modern day, children value time spent playing video games and watching television. New and inexpensive technology has made a rich multimedia experience for children. Children and adults have replaced physical activity with watching more television, and engaging in other forms of using multimedia devices. Children and adults create health risk when they replace physically active behaviors with sedentary behaviors. Physical inactivity is a risk factor for obesity, cardiovascular disease and other chronic diseases that begin during childhood and progress throughout the lifespan. The number of adults and children that get adequate physical activity is decreasing. Children reduce their physical activity during adolescence and only a small percentage of adults meet current physical activity guidelines as established by health care watch organizations. A physically active lifestyle is associated with a number of physical and mental health benefits including maintenance of a healthy weight, improved aerobic and muscular fitness, improved bone mineralization, increased self-esteem and reduced anxiety and stress. Many chronic diseases including cardiovascular disease, type II diabetes mellitus, and osteoporosis have their antecedents during childhood. Youth who are less physically active have a greater incidence of the early metabolic and physiologic manifestations of these diseases. Public health officials have become increasingly concerned about the rapid increase in the prevalence of obesity. Of particular concern is the increasing number of overweight and obese individuals in all age groups, including the very young. The health care costs associated with obesity and physical inactivity are estimated at 9.4% of all direct costs for health care delivery in the United States. In the year 2003 alone, U.S. Government outlays for overweight and obesity were estimated at $175 per taxpayer. Given the increased rate of medical care cost, increased obesity, our aging population; the financial burden passed on to taxpayers will be enormous. The financial and epidemiological trends create a significant marketing opportunity for an effective treatment.

A major factor contributing to the reduction in physical activity is the increased access to sedentary behaviors such as watching television, playing computer games, surfing the Internet and talking on the phone. Unless an effective physical activity intervention is developed and implemented soon, the incidence of negative health effects associated with a sedentary lifestyle will increase dramatically as today's sedentary youth become tomorrow's sedentary adults who will, in turn, be more likely to have sedentary and obese children.

There is a need for a methodology, technology and a system that will stimulate the user's desire to increase their physical activity and exercise; however, there exists a relative paucity of devices for the implementation of behavioral modification programs. But these inventions are of limited scope, are generally difficult to use in practice and are not flexible for use in modifying a wide variety of targeted behavior.

U.S. Pat. No. 6,072,395 issued to Vega on Jun. 6, 2000, shows a traffic light device that signals students engage in behavior. Although the Vega device is an external signaling device used to modify behavior and used to trigger a response, unlike the present invention there is no extrinsic reinforcement based upon performance.

U.S. Pat. No. 6,039,688 issued to Douglas et al. on Mar. 21, 2000, does not pertain to any sort of multimedia experience and relies exclusively on self-report of progress toward a behavioral goal. Douglas' system is not wireless nor is it sensor based. Numerous inventions utilize multimedia devices to display reinforcing messages; however none specifically utilize a multimedia device as the reinforcement.

U.S. Pat. No. 5,784,124 to D'Alitalia issued on Jul. 21, 1998, and U.S. Pat. No. 5,596,994 issued to Bro on Jan. 28, 1997, do not use multimedia access as the reinforcement for good behavior, but rather rely on multimedia only to deliver positive messages to the user. Unlike the present invention, neither the Bro or the D'Alitalia patent provide the ability to accumulate activity points, and transmit them to multimedia devices for access to the selected media device.

U.S. Pat. No. 6,551,104 issued to Becker on Apr. 22, 2003, is restricted to math problems and channel changing and does not utilize multimedia access as reinforcement.

U.S. Pat. No. 6,529,878 issued to De Rafael et al. on Mar. 4, 2003, gives reinforcement to users who participate in advertisers' interactive questionnaires but does not give reinforcement for a variety of behaviors, like the present invention.

U.S. Pat. No. 6,513,160 issued to Dureau on Jan. 28, 2003, reinforces viewers with changes to an icon for their intensity of watching multimedia devices but does not award and allow the accumulation of points for the modification of a variety of target behavior.

Devices for controlling various parameters of video playback during exercise are shown in the relevant art as well. These devices have proven inadequate because they do not allow the user to “bank” credits, that is, store them for later use; but rather, such devices only work in the “on-line” configuration and are limited in scope to exercise. With the exception of U.S. Pat. No. 6,572,511 issued to Volpe on Jun. 3, 2003, these relevant inventions are restricted to a particular exercise machine (i.e. an exercise bicycle) and are limited to use within close proximity to the video output device—and in the case of Volpe's device, the relevant art shows responses to activity, but not reinforcement. Moreover, the relevant art does not show any sort of credit and reinforcement system for use with multimedia. In other words, most of these inventions describe video responses to exercise parameters, but such is far from a credit medium for providing reinforcement for good behavior. Other inadequacies of these patents are described as follows.

U.S. Pat. No. 5,524,637 issued to Erickson on Jun. 11, 1996, describes a system that requires a fixed branching video program and is therefore not readily usable with the abundance of consumer media. It is unlikely that branching video will satisfy the multimedia device consumption preferences of most users. That is to say, each consumer will have a unique preference of multimedia to choose from such as cell phone minutes, computer games, internet access movies, DVDs or other video programs. Therefore, the reinforcing properties of these videos are likely to be minimal and of short duration. Similarly, U.S. Pat. No. 5,527,239, issued to Abbondanza on Jun. 18, 1996, only allows use of the television display during exercise.

U.S. Pat. No. 5,888,172, issued to Andrus et al. on Mar. 30, 1999, is not designed as a reinforcement system. While exercise data area stored on Andrus' system, the data does not translate into multimedia credits (that is to say, there is no token economy). U.S. Pat. No. 6,179,746 issued to Delman on Jan. 30, 2001, is online only and requires a tethered connection to a specially fitted exercise apparatus. U.S. Pat. No. 6,004,243 issued to Ewert on Dec. 21, 1999, is also a real time device and severely restricts the viewing choices of the user. Again, these devices are all connected to an exercise device, and the video response is immediate, unlike the present invention which uses electric points to provide delay between the response and the reinforcement. Behavioral problems can be treated effectively with a properly administered point-based behavioral modification program, and, in many cases, the response to a behavior modification program can exceed that of drug therapies without unintended physiological side effects. Moreover, behavioral modification programs can be particularly effective when combined with drug therapies. Behavior modification programs usually involve the accumulation of points (often indicated by poker chips or marbles handed to the patient or put in a jar) for achieving defined behavioral goals. However, these programs are often difficult to implement for many reasons including the tracking of the delivery of reinforcement, the speed in delivery of reinforcement, or the possible embarrassment to the person getting reinforcement.

Thus, there is a need for a system that provides multimedia enjoyment and encouragement as reinforcement for desired behavior. Further, there is a need for a method of providing electronic credits that can be traded in for reinforcement at a time and place after the desired behavior has been exhibited.

### SUMMARY OF THE INVENTION

There is a need for a system that will allow the multimedia experience to serve as a reinforcement system to encourage children and adults to engage in physical activity and other targeted behaviors. The present invention is a system of methodology, technology and devices that allow the user to earn and accumulate points based on physical exercise or other targeted behavior and exchange the points for the use and access to multimedia devices and entertainment.

The present invention can be used for, but is not limited to, the implementation behavior modification programs for the treatment and prevention of diabetes (i.e., through the promotion of exercise and encouragement of healthy eating habits), classroom- and home-based therapies used for the treatment of certain pediatric neuropsychiatric disorders (e.g., Attention Deficit Hyperactivity Disorder, Autism/Asperger's Disease), inpatient and outpatient treatment of adult psychiatric disorders including schizophrenia, Huntington's Disease, obsessive compulsive disorder, the cessation of smoking, treatment of alcohol and drug addiction, behavior modification programs used in corrections facilities (e.g., reinforcement for compliance with prison rules), and behavioral modification programs in the home (e.g., completion of homework, cleaning room). The current preferred embodiment is as a behavioral system to promote healthy living through exercise.

The present invention has several theoretical components. First, the present invention allows a user to earn points. Second, the points are earned for meeting criteria defining a targeted behavior. Third, the points can be redeemed for time with a multimedia device or access to multimedia entertainment.

The present invention provides a means of utilizing a multimedia device, a readily available, powerfully reinforcing, and low cost or essentially free resource as reinforcement for behavioral performance. The present invention communicates with a wide variety of sensors and devices, thereby making it a general-purpose behavioral modification device. Wireless communications, incorporated within the present invention, enable the user to be far away from the device when reinforcement is delivered.

Specifically, the present invention consists of developed technology to implement behavioral contingencies using media access as reinforcement. The method utilizes commonly available wireless and embedded microprocessor technology. A controller limits access to media devices; stores point balances, and blocks the user's access to the media device when there are not sufficient points in the account balance. The application of this technology to increase physical activity requires individuals to earn points by engaging in a wide variety of physical activities of their choosing. A sensor/transmitter unit is built into common exercise equipment and activity monitoring devices. Because the technology is wireless and embedded, the user can earn points for exercise at virtually any time and any place. The user need not be in the vicinity of the media device in order to gain points and there is no requirement that the subject exercise while using the media device. The present invention has intervention benefits by simultaneously increasing active and reducing sedentary behaviors. The method utilizes behavioral engineering approaches to physical activity. In addition, the present invention permits the implementation of a programmable individually tailored set of reinforcement criteria such that each user can begin an exercise program at a therapeutic level of intensity level and move toward a more rigorous goal through approximation. A reinforcement schedule can be used to programmatically control the timing and delivery of reinforcement for meeting the criteria.

The present invention is applicable to a wide variety of behavioral modification programs. In one embodiment of the present invention, one multimedia control device can be used for multiple members of a target group. Therefore, a family wishing to modify behavior in one member and modify the same or a different behavior in a second member, only needs to purchase one multimedia control device for each media device and a set of sensors for each target behavior.

The present invention converts a freely available, strongly reinforcing resource into a source of reinforcement. In addition, the present invention reduces multimedia consumption (linked to obesity, diabetes, behavioral and educational problems) because a multimedia device will only be used per the points accumulated for desired behavior.

### BRIEF DESCRIPTION OF THE DRAWINGS

FIG. 1 is a view of the technology in schematic form.

FIG. 2 is a front view of a general purpose sensor/transmitter module.

FIG. 3 is a top view of a General Purpose Sensor Transmitter Module with attached accelerometer and embedded in a dumbbell weight.

FIG. 4 is a front view of a wrist watch point accumulator.

FIG. 5 is a front view of a computer network point accumulator.

FIG. 6 is a front view of a cell phone point accumulator.

FIG. 7 is an environmental view of a TV regulator.

FIG. 8 is a top view of a computer network regulator.

FIG. 9 is a front view of a cell phone regulator.

### DETAILED DESCRIPTION

The present invention is a system to control, alter or promote a desired behavior. The present invention has three units that work together to achieve their common goal of altering a behavior. Activity sensors (10), point accumulators (30) and media regulators (50).

FIG. 1 provides an overview of the technology in schematic form. The technology is composed of devices from three functional classes activity sensors (10) detect exercise responses and send points to any given point accumulator (30); point accumulators (30) allow the user to gather points in the field, temporarily store them in memory, and transfer them to any media controller in the home. Point accumulators (30) are most often wearable (e.g., cell phone, wrist watch, or belt clip) but can also be implemented directly on the media controllers.

The participant wears a point accumulator (30) (a wristwatch or other portable device) and logs on to any of the activity sensors in order to earn points. The sensors are depicted as embedded in a medicine ball, free weight, yard work tools, and running shoes, but any, variety of potential applications exist.

FIG. 2 shows a general purpose sensor/transmitter module (GPSTM) (15) built for measuring and evaluating the exercise response and transmitting points to the point accumulator (30). The module consists of a PIC microcontroller (20) (Microchip Corp., Mesa, Ariz.), a BlueTooth chipset (22) (BlueGiga Technologies, Finland), and rechargeable power supply circuitry (24). Each module includes three logic and four analog-to-digital conversion (ADC) channels (not shown in figure). Switches and transducers connected to these channels (also not shown in figure) are used to detect exercise repetitions and intensity. The microcontroller (20) provides on board FLASH memory (26) so that data can be stored on the chip itself. This enables post-deployment control of sensor parameters such as threshold and gain, the measurement of battery reserves, and the “tuning” of the reinforcement algorithm to different components of the exercise response. The size of the sensor module including batteries and transducers is 1.25″×1.25″×1.5″. The GPSTM can also be configured to send the data values acquired on the ADC and digital channels to a computer for logging. This capability is referred to as remote data acquisition mode. The ability to perform remote data acquisition allows for the development of routines off-line that can be later implemented on the GPSTM itself.

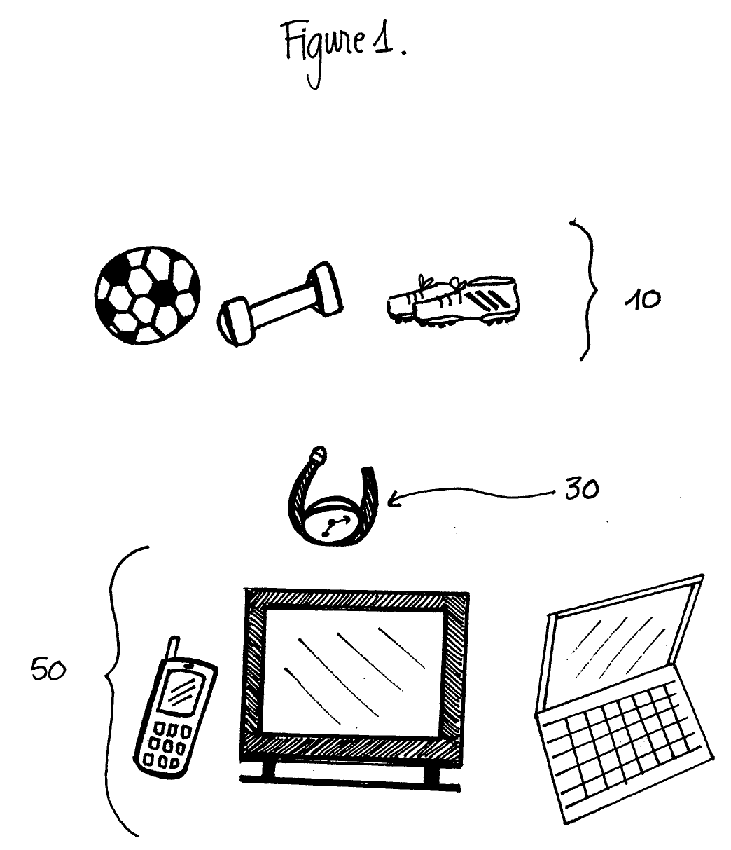

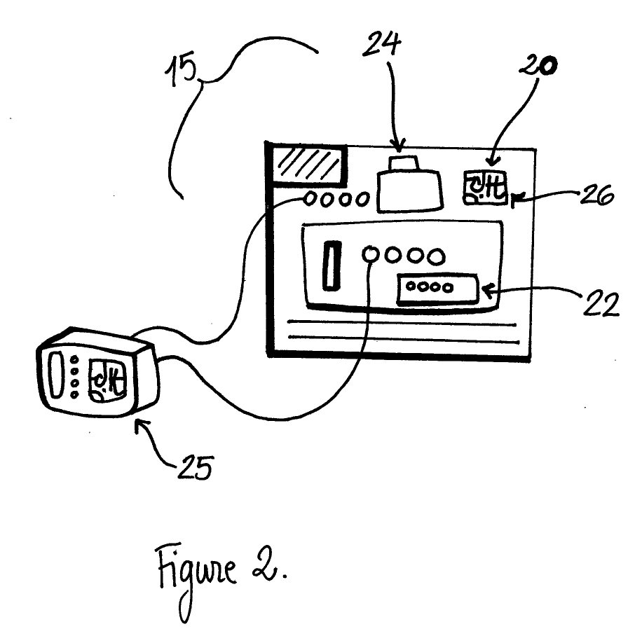

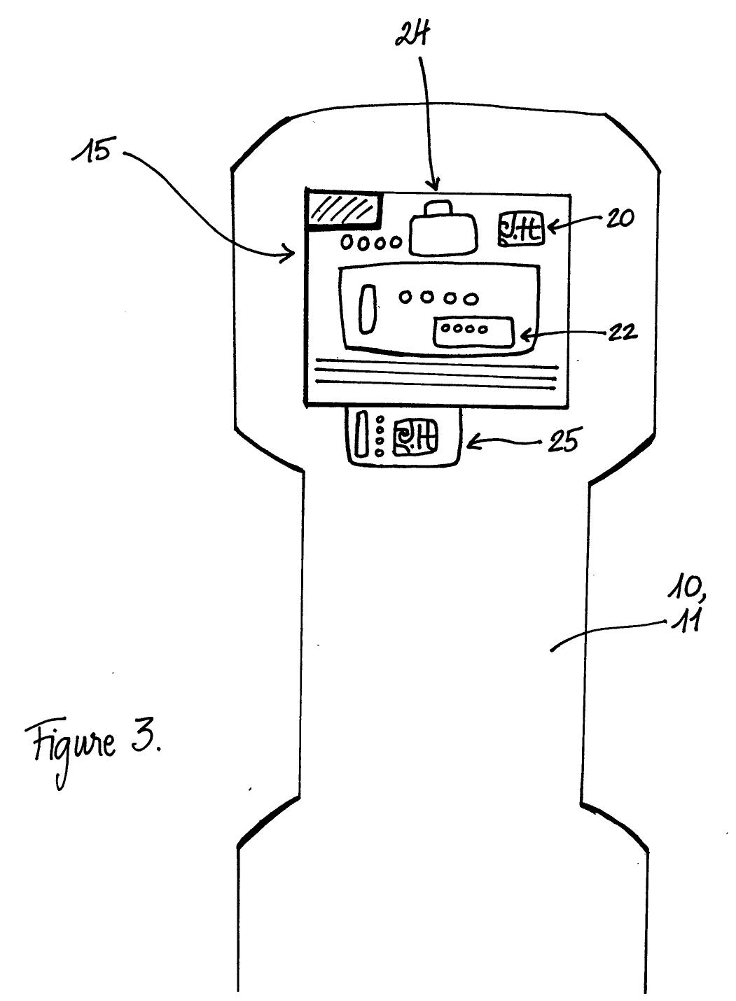

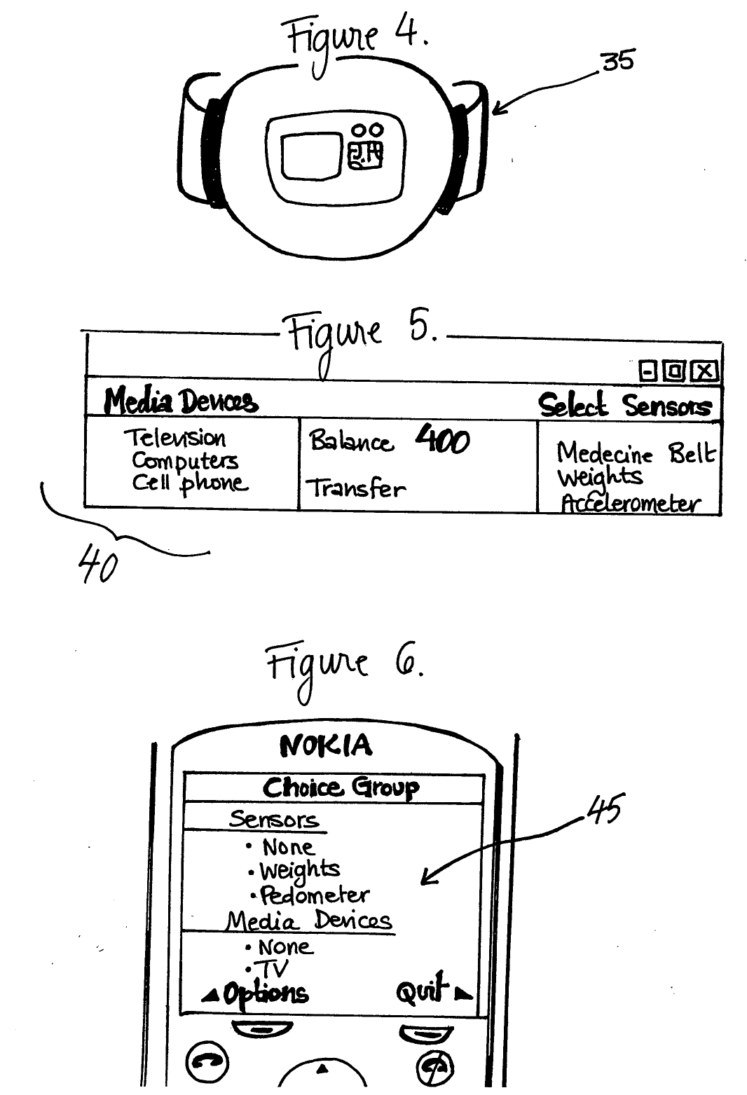

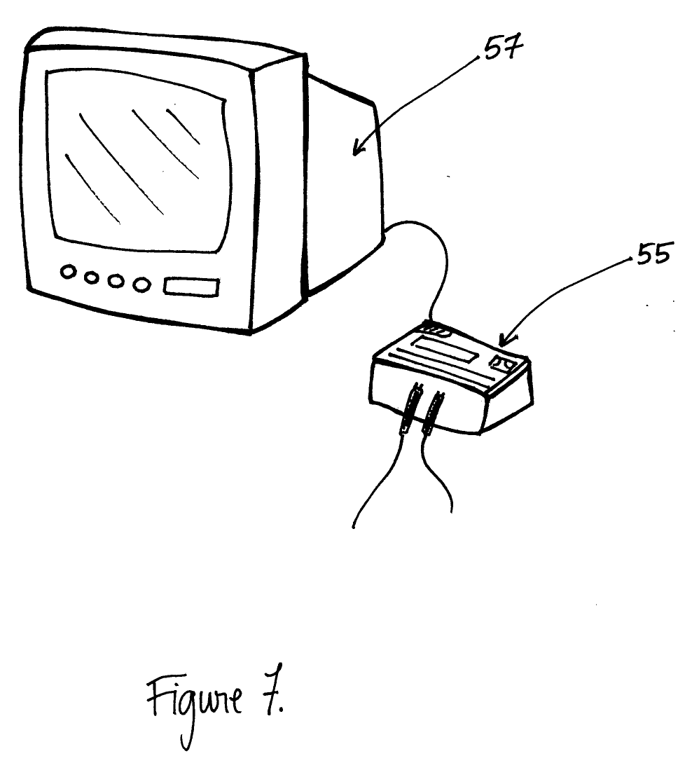

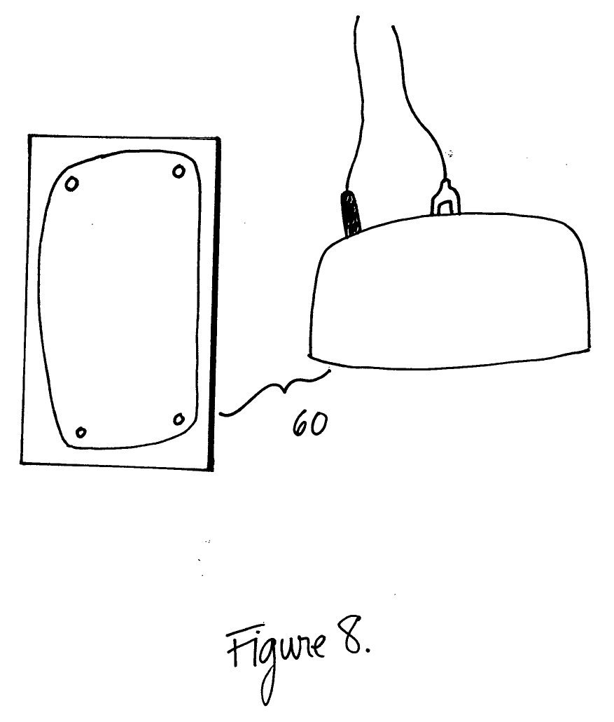

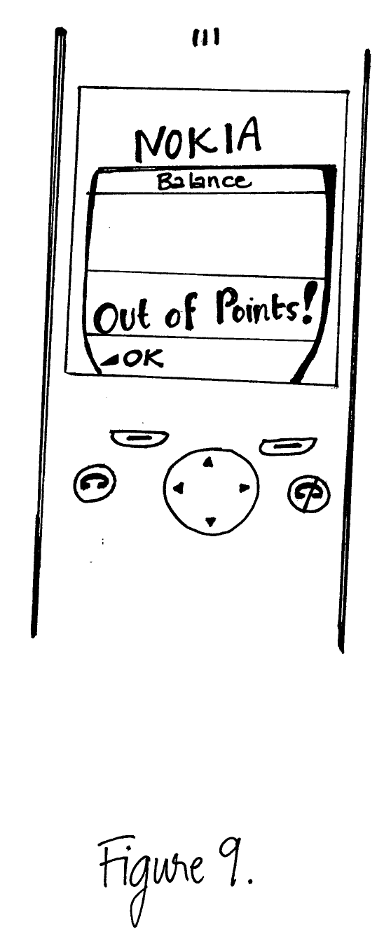

FIG. 3 shows the GPSTM (15) with attached accelerometer shown embedded in a dumbbell weight (11) an example of an activity sensor (10). The GPSTM (15) consists of a power supply circuitry, a micro-controller (20) and a Bluetooth chipset (22). An accelerometer test board (25) is shown in the lower left hand comer of the photo. The battery is not shown. The GPSTM (15) with attached accelerometer (25) is shown embedded in a prototype 25 pound dumbbell (10). The GPSTM (15) is small enough to be embedded in commercially available dumbbells and barbells as light as 1 pound. Point accumulators (30) allow the user to log on to an exercise sensor (15) and accumulate points. The user can then use the device to log on to a media controller (50) and transfer any accumulated points to a user account. Three point accumulators (30) have been developed (shown in FIGS. 4-6): In FIG. 4, a wristwatch point accumulator (35) (FIG. 5, a computer network and (40), FIG. 6, a cell phone (45). The wristwatch point accumulator (35) offers the most portability because of its small size (1″×2″×2″). Other permutations of the design include a keychain and a belt clip. The design consists of a PIC microcontroller (20) (Microchip Corp., Mesa, Ariz.), a BlueTooth chipset (not shown) (BlueGiga Technologies, Finland), two buttons (not shown) and a liquid crystal display (not shown) (Hitachi LM018L; Hitachi Corp., Japan). The computer network and cell phone accumulators (40,45) are software implementations with similar functionality to the wristwatch point accumulator (35). Each utilizes the hardware provided with the computer network (40) and cell phone (45) media controllers. The computer network point accumulator (40) must remain connected to the home computer network and is, therefore, not portable; however, the user can make wireless contact with the device from within a 100 m radius. The cell phone point accumulator (45) can be carried with the subject. The 100 m radius applies to the cell phone; therefore, the phone could be taken to a gymnasium or on a bike ride.

The prototype wristwatch point accumulator (35) shown in FIG. 4 will be reduced from its current size of (6″×4″×1″) to the size of a wristwatch. This device will be the most portable of the three accumulators.

FIG. 5 shows a screen shot of the computer network accumulator (40) Java software running on a laptop computer. The computer network accumulator (40) is not portable; however it can be used to accumulate activity points occurring within a 100 m radius of the computer.

The cell phone accumulator (45), shown in FIG. 6, consists of software running on a cell phone and can be carried with the user during most targeted physical activities.

FIG. 7-9 shows the three media regulators (50): The TV regulator (55), as shown in FIG. 7, utilizes the closed captioning data channel (also known as Line 21 Vertical Blanking Interval data) to display information to the user and disable the screen when the point balance is zero. The device is connected between the output of the tuner (VCR or cable box) (57) and the television (55). The Zilog Z86239 Line 21 data encoder/decoder (Zilog Corp., San Jose, Calif.) was chosen to encode the video signal because of its low cost, relative ease of programming, and ability to adapt the display text (size, color, brightness). The Z86239 is connected to a Zilog Z8 Encore microprocessor and a 256K electrically erasable programmable read-only memory (EEPROM) for the storage of user and experimental data. The size of the TV regulator is 2″×6″×4″.

The computer network regulator (60), as shown in FIG. 8, utilizes a Wireless Remote Access Platform Access Server (WRAP AS; BlueGiga Technologies, Finland) that can be connected to a single non-networked computer or any number (typically 2 or 3) of computers on a home network. Due to the availability of the WRAP AS, no hardware development was required for the development of this prototype. The design is implemented through a suite of Java (Sun Microsystems, Cupertino, Calif.) programs that assess charges and store user data using the computer's native capabilities. The software is designed so that whenever a user logs on to a computer on the network, charges are made against the user's account.

The cell phone regulator (70) as shown in FIG. 9 utilizes the native BlueTooth communications, display, and processing capabilities of the cell phone. The initial design is implemented on a Nokia 6600 (Nokia Corp., Finland) cell phone (75); the screen (77) indicates that the user has run out of points. However, many commercially available cell phones have similar capabilities. The software is written in the Java ME computer language (Sun Microsystems, Cupertino, Calif.) with JSR-82, the Java APIs for Bluethooth programming classes. In the event that the user does not have anymore points on their account and an emergency arises a special provision is made for the user to make emergency 911 calls.

It is intended and should be understood that the present invention is not limited solely to the particular embodiments aforementioned. The detailed description is simply to be illustrative, and the present invention should be viewed to encompass any and all embodiments that fall within the scope of the following claims.

I claim:

1. A behavior modification device, comprising:
a sensor;
a point accumulating device, in communication with said sensor; and
a multimedia device, in communication with said point accumulating device.

2. The device of claim 1, wherein said behavior modification device has a micro-processor for controlling said information derived from said devices.

3. The device of claim 1, wherein said sensor is an exercise monitor.

4. The device of claim 1, wherein said point accumulating device is I incorporated into a watch.

5. The device of claim 1, wherein said multimedia device is electronic media.

6. The device of claim 1, wherein said sensor receives input from a user.

7. The device of claim 1, wherein said sensor receives input automatically.

8. The device of claim 7, wherein the points are transmitted to said point accumulating device.

9. The device of claim 8, wherein said point accumulating device transmits the points to said multimedia device.

10. The device of claim 1, further comprising a multimedia input device in communication with said multimedia device, wherein said point accumulating device communicates with said multimedia input device.

11. The device of claim 1, wherein said multimedia device only operates when prompted by said point-accumulating device.

12. The device of claim 1, wherein said point-accumulating device only operates when prompted by said sensor.

13. A behavior modification device, comprising:
a sensor;
a central server, in communication with said sensor; and
a multimedia device, in communication with said point accumulating device.

14. The device of claim 13, wherein said central server distributes software components.

15. The device of claim 13, wherein said central server controls software components.
